(19) United States
(12) Patent Application Publication
(10) Pub. No.: US 2009/0173830 A1
(43) Pub. Date: Jul. 9, 2009

(54) Rocket-powered kite plane for gentle climb and acceleration to extreme staging altitudes

(76) Inventor: Leonard N. Cormier, Fairfax, VA (US)

Correspondence Address: ROBERTS MLOTKOWSKI SAFRAN & COLE, P.C.;Intellectual Property Department, P.O. Box 10064, MCLEAN, VA, 22102-8064, US

(21) Appl. No.: 11/408,164

(22) Filed: Apr. 21, 2006

(51) Int. Cl. B64G 1/14; B64G 1/40; B64G 1/00

(52) U.S. Cl. 244/159.3; 244/171.1; 244/172.2

(57) ABSTRACT

A two-stage space vehicle is provided for achieving low earth orbit that includes a carrier and an orbiter. The carrier has a large airfoil area relative to its dry weight, and the thrust of the rocket engine is controlled such that the carrier achieves a launch altitude and speed for the orbiter without exceeding a wingloading pressure beyond 3,500 Pa., which allows the carrier to be inexpensively constructed. Liquid propellant for the rocket engine is advantageously stored within the relatively large airfoil of the carrier, which is preferably a delta wing. The ratio of airfoil area to dry weight is about 33 m² per ton, which allows the carrier to descend and land after launching the orbiter with low wingloading on the order of 300 Pa.

### FIELD OF THE INVENTION

This invention is generally concerned with a high altitude aircraft, and is specifically concerned with an ultralight, large lift surface, rocket propelled aircraft for obtaining extreme altitudes suitable for staging with a second stage capable of reaching low Earth orbit.

### BACKGROUND OF THE INVENTION

Various approaches to both expendable and reusable designs for space launch vehicles are known in the prior art. In most of these approaches, rocket propulsion supplies the primary, if not exclusive means for lift. Relatively little of the lifting forces are generated aerodynamically. This is particularly true for vertical takeoff designs, wherein wings are generally superfluous for climb and acceleration. Horizontal takeoff designs are known, wherein aerodynamic lift allows reduction in engine thrust to help compensate for wing mass. However, horizontal takeoff designs favor relatively small wings to allow efficient climb and acceleration at relatively high speed. By contrast, large wings are largely incompatible with atmospheric, supersonic and hypersonic flight, particularly in combination with air-breathing engines. The consequent exclusive or near exclusive reliance on rocket power to generate lift is expensive in terms of propulsion system acquisition and maintenance costs and also in terms of the structural loads imposed by exposure to high dynamic pressures. While rocket planes such as the X-15 are also known which are able to obtain a substantial amount of lift from wings or other airfoil surfaces, the high speeds that these vehicles are operated at again limits the amount of wing surface and hence the lift that can be obtained from airfoils, which again results in a requirement for ballistic flight, rather than lifting flight, at high altitudes. Finally, while high altitude jet aircraft having relatively large area airfoils are know, such a the U-2 “spy” aircraft used by the United States Air Force, the use of an air-breathing engine limits the altitude that such an aircraft can obtain. Moreover, wing shape and the air inlet constraints for the air-breathing engine prevent U-2 type aircraft from flying at the hypersonic speeds necessary to achieve low earth orbit.

### SUMMARY OF THE INVENTION

Generally speaking, the space vehicle of the invention comprises the combination of a rocket engine with a vehicle body having high ratio of airfoil area to system mass, together with placement of propellants within the airfoil. In flight, the rocket engine is operated at a relatively low thrust to limit the dynamic pressures applied to the body of the vehicle. The resulting relief from dynamic structural loads permits the large airfoil area (which is mostly in the form of large wings) to be constructed from ultralight aircraft components.

Rocket power in combination with large wings allows lifting flight at much higher altitude than previous approaches. The volume within the relatively large wings provides sufficient space for the large amount of propellants required by the rocket engine and obviates or at least drastically reduces the need for fuel tanks outside of the airfoil surfaces that compromise aerodynamic efficiency. The rapid expenditure of the propellants enhances the ability for flight at greatly reduced mass at extreme altitudes where rocket propulsion performs well. Climb and acceleration at the relatively slow speed required by this approach results in a potential for the use of airfoil surfaces formed from very lightweight skin panels and lightweight truss structures which make large wings practical. While this approach tends to require more propellant than other approaches to reach equivalent energy levels, the disadvantages of requiring extra propellants are small, while the advantages of the gentle flight to these levels are large, and include the ability to construct the vehicle with many off-the-shelf components and a minimum amount of exotic and expensive materials. The most likely application of this approach is for the first stage, also called the carrier, of a two-stage-to-orbit space transport. This, in turn, permits staging of a TSTO space transport at extreme altitudes. We define our term “rocket-powered kite plane” to be an aircraft as described above, that uses a high ratio of wing area to system mass in combination with rocket power to reach extreme altitude, and, in some embodiments, high speed, in a manner that sharply reduces aerodynamic loads due to high dynamic pressures and mismatches of aerodynamic and inertial loads to permit the use of ultralight-type aircraft components.

Ultralight structures require constraining dynamic pressures during ascent and acceleration, which is generally inefficient for rocket propulsion. However, this inefficiency is more than offset by the resulting light, simple structures for both the carrier stage and the reusable second stage, or orbiter, and the potential for superior system performance and economics.

Although operating a rocket propelled vehicle in such a way as to constrain dynamic loads is generally fuel inefficient, this is inefficiency is of little consequence. Once the propellants are used, the mass of the used propellants has no further effect on performance, and the tanks containing the required additional propellants are relatively light. If the propellants are liquid oxygen and kerosene, as they are in the preferred embodiment, the extra propellants also have only a relatively small impact on cost per flight. Engine size for this approach is typically set by the ballistic part of the trajectory when most of the propellants have already been expended. The relatively low thrust-to-weight at takeoff is quite acceptable because of the low wing loading, lifting trajectory for the earlier portion of the flight. In the preferred embodiment, we are even able to lose one of the two carrier engines and still sustain flight for safe abort. There is little impact on engine maintenance, since neither a restart nor throttling are required and since we use the engines that are derated for relatively low maintenance in spite of longer flight times. There is no impact on takeoff gear in the preferred embodiment, since we use a relatively low-speed takeoff cart, and the carry-along landing gear is designed by landing weight. This landing gear is generally designed for crosswinds, in deference to the extremely low wing loading of the carrier at normal landing weight. As a consequence of all this, rocket propulsion provides adequate thrust at extreme altitudes and over a wide range of mach numbers in a straight-forward, cost-effective manner. Specifically, combining rocket propulsion with a low wing-loading approach promises to be a highly beneficial—if unusual—design approach for a near-term cost-effective, space transport that does not depend upon exotic technology.

For the carrier stage, the inventor has considered: a) subsonic versions with large open truss structures and fabric covering in high aspect ratio wings; b) low supersonic, lower aspect ratio versions with fabric covering; and c) high supersonic and low hypersonic, low aspect ratio versions with lightweight metallic sandwich panels that carry aerodynamic loads into open truss areas than fill in areas between shaped propellant tanks to form the carrier wing structure. The subsonic version is the simplest, lowest-cost version of the carrier. This version also allows the carrier stage to takeoff separately at low speed, with carrier propulsion, tankage, and orbiter suspended below the carrier wing—much in the fashion of a kite with a suspended payload. The low supersonic version increases performance potential substantially while retaining the weight and cost advantages of the fabric coverings. The high supersonic version requires metallic sandwich skin panels that are significantly heavier and more costly; however, the performance and net cost advantages seem to favor high supersonic, low hypersonic staging, and this is the currently preferred embodiment. The metallic skin panels are still relatively light compared to stressed skin wing structures wherein the skins carry much of the wing bending loads; accordingly, we still consider the high supersonic staging version to be a “kite plane.”

The Space Van 2010—the currently preferred embodiment of the “kite plane” approach—stages at mach 5.5 at 81.5 km altitude. As with other versions of the “kite plane,” we cite two main benefits: a) the orbiter is relatively unconstrained in size and shape and is never subjected to large aerodynamic and heating loads that would otherwise designing the orbiter's structure; and b) the carrier stage itself is relatively low tech—and is much lighter and less expensive than a more conventional large carrier aircraft with airbreathing propulsion.

### BRIEF DESCRIPTION OF THE DRAWINGS

FIG. 1A is a plan view of the two-stage system that comprises a carrier stage and an orbiter stage employing the main features of the invention in the preferred embodiment, i.e. use of rocket propulsion with a relatively large wing, careful placement of propellants and payload for relieving structural loads, an constraints on maximum dynamic pressure to permit ultralight aircraft structural approaches, lifting flight at much higher altitudes and a potential for takeoff, climb, and acceleration to orbit in a cost-effective manner.

FIGS. 1B, 1C, 1D and 1E are side view, front view, rear view and perspective view respectively.

FIG. 2 illustrates the current placement of propellants and carrier payload, the orbiter, in order to achieve highly effective limitation of structural loads that permit application of ultralight approaches to a large wing.

FIGS. 3A, 3B, 3C, 3D and 3E are plan, side, front, rear and perspective views of the orbiter stage that benefits greatly with respect to structural design by reaching the staging point in a gentle and protected manner. The orbiter shown in FIGS. 3A, 3B, 3C, 3D and 3E is designed primarily for a space tourism application, and features an oversize cabin.

FIG. 4 is a perspective view of the cargo version that features a large cargo bay and hatch in lieu of the large passenger version featured in the space tourism version.

FIG. 5 shows the current trajectory for the carrier stage with the fully loaded orbiter on board.

FIG. 6 shows the current trajectory for the orbiter stage after the staging point.

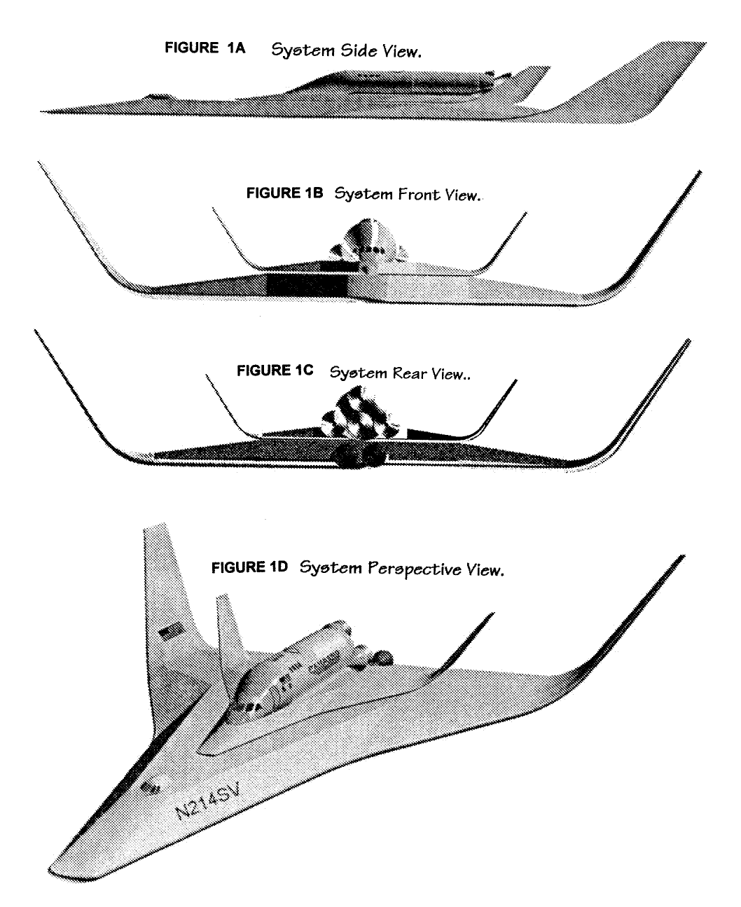

### DETAILED DESCRIPTION OF THE PREFERRED EMBODIMENT

With reference to the various figures, wherein the numerals designate like components throughout all the several figures, the invention finds particular application in this preferred embodiment. This preferred embodiment is a TSTO space transport, comprising a carrier as the first stage and an orbiter as the second stage.

The carrier features a large, 1000 m² wing that is significantly larger than might otherwise be considered for a space launch application employing horizontal takeoff and landing. This unusually large wing results in a relatively gently ride to the staging point for the orbiter, the structure of which benefits greatly from being designed for mechanical and thermal loads typical of a low planform reentry. Unlike other horizontal takeoff or vertical takeoff space transports, the orbiter stage does not experience the large structural and panel loads normally encountered in climb and acceleration to the staging point. This relief, in turn, permits a larger orbiter wing that further reduces thermal and structural loads on the orbiter. The empty or dry weight of the carrier is about 30 tons, whereas the weight with a full load of propellant is about 280 tons. The weight of the orbiter vehicle is about 80 tons.

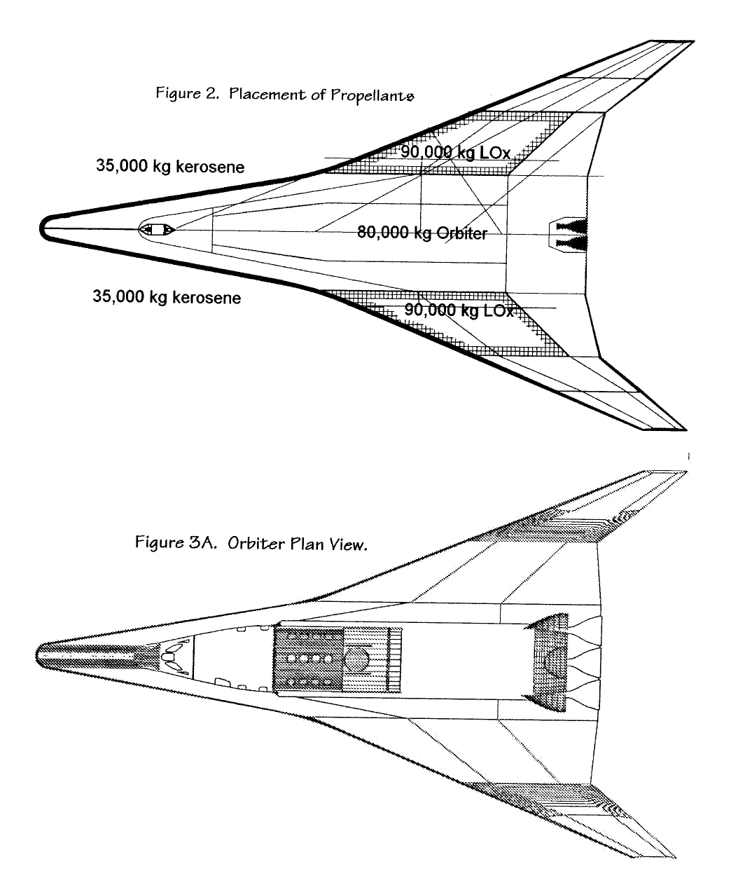

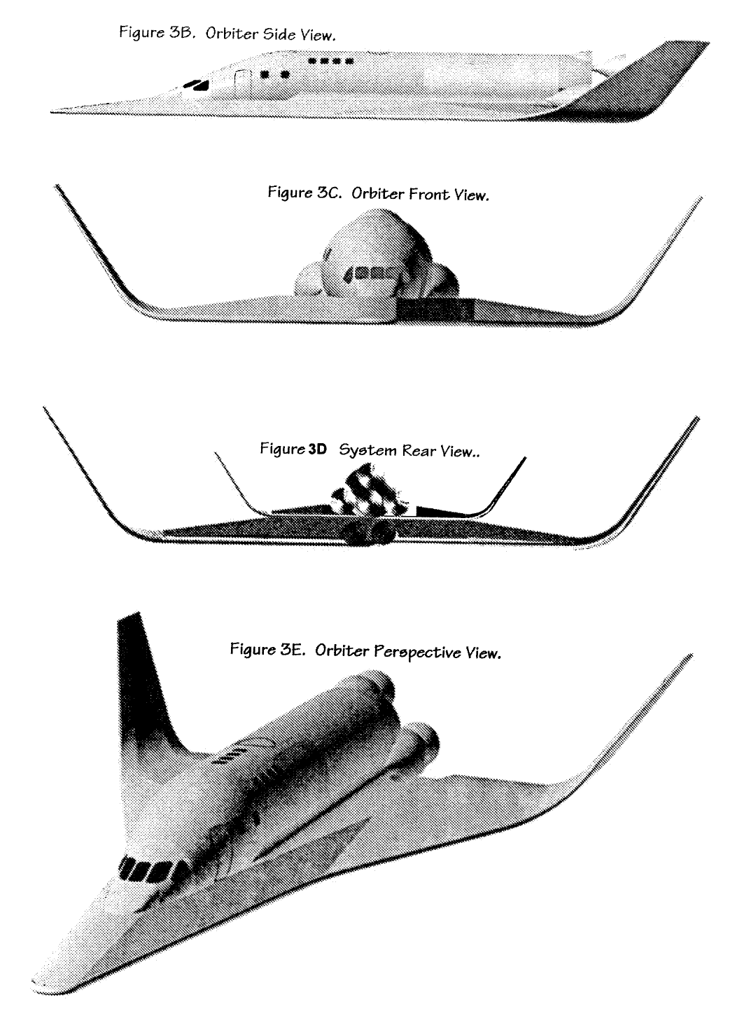

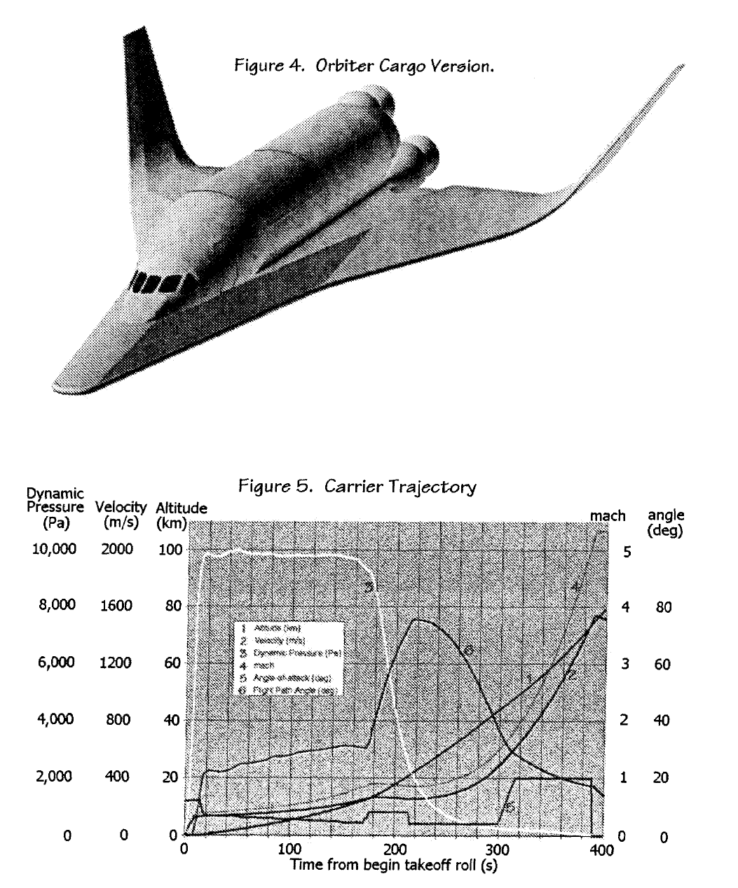

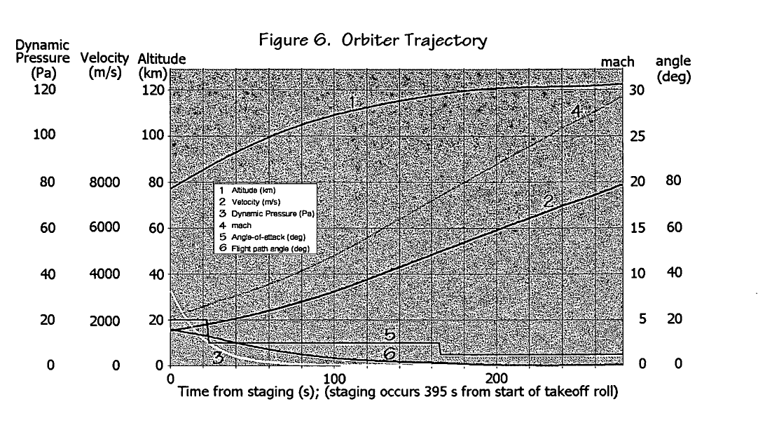

Ultralight structure for the wings of small aircraft is well know in the prior art, and generally relies on fabric-covered truss structure, rather than “stressed-skin” wing structures typical of high performance aircraft. Rocket acceleration vehicles typically have high propellant fractions. Accordingly, careful placement of this propellant as shown in FIG. 2 permits much larger “ultralight” wings that carry primary loads in trusses, with lightweight skin panels designed to carry local aerodynamic loads into the basic truss structure. Since the mass of the carrier stage may be as much as 90 percent propellant, it is also appropriate to shape the propellant tanks in such a way as to be integrated into part of the carrier wing structure. Careful placement of the large amount of carrier rocket propellants, together with constraints on maximum dynamic pressure, enable ultralight structure, in spite of the 41-m wing span.

With the preferred embodiment design, loads within the carrier wing structure can be low enough to prefer truss-like structural components for the main truss structure. For this purpose, the very lightweight, strong structures designed and manufactured by IsoTruss Structures, Inc. IsoTruss structures appear to be adaptable and appropriate for the vertical column parts of the carrier wing structure, and may be appropriate for other parts of the truss structure as well.

In the preferred embodiment, the carrier is powered by two Aerojet AL26-58 LOx/kerosene rocket engines that are basically reworked Russian Kuznetsov NK-33 rocket engines. These engines are highly reliable, reusable and maintainable—especially when derated to 80 percent maximum power as intended for the preferred embodiment. Even at takeoff gross mass, wing loading with the large carrier wing is low enough to permit takeoff at about 200 knots, with the ability to abort safely in the event of loss of one engine immediately after takeoff. Assuming propellants are used or jettisoned, the carrier can land with the orbiter still attached. Top mounting of the orbiter is not a problem at staging, since the dynamic pressure is only about 17 Pa at staging.

The large wing and careful placement of propellants is highly beneficial with respect to design of the carrier wing. The main benefit of the system design approach, however, is the relief provided for orbiter structural design by avoiding large aerodynamic, mechanical and thermal loads during the exit portion of the trajectory to orbit. Additional relief is provided by the design of the carrier and orbiter wings that allows the lower surface of the orbiter to be protected by being mounted flush against the flat inboard upper surface of the carrier wing, thus shielding the lower skin panels of the orbiter and bracing the orbiter internal wing truss structure. Thus, the orbiter structure is essentially designed by reentry and landing requirements. The large carrier wing also relieves geometric constraints on orbiter design. This, along with low reentry and landing loads, allows the orbiter wing to be relative large, with lower reentry heating resulting from low planform loading. Low planform loading is a feature and a basic requirement for our earlier thermal protection system patent, U.S. Pat. No. 4,919,366.

The orbiter's twin outboard tail surfaces have special design features that we have used on a number of our previous designs leading up to the Space Van 2010. Sharp intersections can lead to serious reentry heating problems that were never solved on the Dyna Soar program. We have solved this problem by: a) avoiding heating problems during the exit trajectory; b) reducing heating problems during reentry with our low planform approach; and c) by using a generous 2-m radius in the transition section from the wing to tail surfaces. The carrier stage uses a similar tail configuration primarily for symmetry, aesthetic and mating integration reasons. However, the carrier tail surfaces use conventional, hinged rudder surfaces. The orbiter tail surfaces are designed to pivot outboard for directional control as well as stability purposes. By pivoting outboard, the whole tail surface contributes both differential drag and directional lift forces for directional control. When canted outboard an equal small amount, i.e. 5 degrees, these surfaces also add to directional stability by providing stabilizing lift and drag forces.

With the solution of the heating problems normally associated with tip tail surfaces, such surfaces are much more effective than centerline tail surfaces that are largely blanked out at high angles of attack at hypersonic speeds.

In operation, both the carrier and the orbiter are loaded with propellant and mated. The rocket engines of the carrier are then ignited and then operated at a thrust level such that the airfoil surfaces of the carrier experience a maximum wingloading of about 3,500 Pa. at takeoff. As the carrier and orbiter proceed to gain altitude, the wingloading continuously decreases. Even though the rocket engines are operated at a substantially constant thrust, the velocity of the carrier and orbiter slowly increases due to the continuous loss of propellant weight. The vehicle remains subsonic until about 18 kilometers altitude, when the reduced weight of the carrier allows the constant thrust of the rocket engines to accelerate the vehicle beyond the sound barrier. Supersonic flight is often accompanied by substantial increases in dynamic pressure loads and drag on the airfoil surfaces. However, due to the low density of air at 18 kilometers, the wingloading is less than 3500 Pa. The vehicle continues to accelerate to hypersonic speeds until it reaches an altitude of about 81.5 kilometers and a velocity of about mach number 5.5. However, the wingloading is only about 1000 Pa. at this point since the vehicle is largely out of the earth's atmosphere. The orbiter is then launched, and the very small amount of air remaining at this altitude allows the carrier to use its wings to pull down from the orbiter and then bank away from the detached orbiter. The orbiter ignites its rocket engines and accelerates to the mach number 29-30 speed necessary to achieve low earth orbit. In the meantime, the carrier re-enters the atmosphere at a shallow angle and at a relatively low speed (compared to orbital speeds) thereby minimizing the dynamic and thermal loads applied to the airfoil surfaces as it prepares to land. The very low weight and large wing area of the descending carrier allows it to re-enter and land with a wingloading of only about 300 Pa.

What is claimed is:

1. A space vehicle comprising:
a carrier having an airfoil and a rocket engine, wherein said airfoil includes storage space for storing liquid propellant for the rocket engine, and wherein the ratio of airfoil area to dry weight of the carrier is between about 28 to 38 m²/ton.

2. A space vehicle in accordance with claim 1, further comprising an orbiter matable to the carrier.

3. A space vehicle in accordance with claim 2, wherein the orbiter includes a substantially flat bottom surface that is mated to a complementary surface on the carrier such that the bottom surface of the orbiter is protected during ascent of the carrier.

4. A space vehicle in accordance with claim 1, wherein the carrier airfoil includes a delta wing.

5. A space vehicle in accordance with claim 1, wherein all of the liquid propellant for the rocket engine is stored within the airfoil of the carrier.

6. A method for achieving low earth orbit with a space vehicle that includes a carrier having an airfoil and a rocket engine, and an orbiter mated to the carrier, comprising the steps of:
filling volume within the airfoil of the carrier with liquid propellant for the rocket engine;
activating the rocket engine to achieve a horizontal takeoff of the carrier and orbiter;
operating the rocket engine at a thrust level such that the airfoil surfaces of the carrier experience a maximum wingloading of 3,500 Pa. between takeoff and landing of the orbiter.

7. The method for achieving low earth orbit in accordance with claim 6, wherein the ratio of airfoil area to dry weight of the carrier is between about 28 to 38 m²/ton.

8. The method for achieving low earth orbit in accordance with claim 6, further comprising the step of maintaining a sub-sonic speed until an altitude of between about 15 and 21 kilometers has been achieved by the carrier, whereupon a supersonic speed is attained.

9. The method for achieving low earth orbit in accordance with claim 8, further comprising the step of launching the orbiter when the carrier reaches an altitude of between about 76 and 86 kilometers and a speed of between about mach number 5 and 6.

10. The method for achieving low earth orbit in accordance with claim 6, further including the step of operating the rocket engine of the carrier after launching of the orbiter such that the airfoil experiences a maximum pressure of between about 250 and 800 Pa. during descent and landing.
